(19) United States
(12) Patent Application Publication
(10) Pub. No.: US 2024/0181698 A1
(43) Pub. Date: Jun. 6, 2024

(54) MULTIMODAL MOTION SYSTEM FOR ADDITIVE MANUFACTURING

(71) Applicant: Kalos Technology Group, Erie, PA (US)

(72) Inventor: Jacob Williams, Stewartstown, PA (US)

(73) Assignee: Kalos Technology Group, Erie, PA (US)

(21) Appl. No.: 18/524,928

(22) Filed: Nov. 30, 2023

Related U.S. Application Data
(60) Provisional application No. 63/385,693, filed on Dec. 1, 2022.

(51) Int. Cl. B29C 64/232; B29C 64/118; B29C 64/209; B29C 64/236; B29C 64/245; B29C 64/393; B33Y 10/00; B33Y 30/00; B33Y 50/02

(52) U.S. Cl. CPC B29C 64/232; B29C 64/118; B29C 64/209; B29C 64/236; B29C 64/245; B29C 64/393; B33Y 10/00; B33Y 30/00; B33Y 50/02

(57) ABSTRACT

A manufacturing system is disclosed. The system may include a tool head, a platform and a positioning assembly. The tool head may extrude a material and the platform may receive the material extruded from the tool head. The tool head and the platform may both be configured to move in an X-Y plane. The positioning assembly may be configured to operate in three operational modes. The positioning assembly may cause a tool head movement and a platform movement simultaneously in opposite directions in the X-Y plane at a same speed when the positioning assembly operates in a first operational mode.

### CROSS-REFERENCE TO RELATED APPLICATION

This application claims priority to and the benefit of U.S. provisional application No. 63/385,693, filed Dec. 1, 2022, which is hereby incorporated by reference herein in its entirety.

### TECHNICAL FIELD

The present disclosure relates to a multimodal motion system for additive manufacturing, and more specifically to a system for additive manufacturing having a tool head and a platform both configured to simultaneously move in an X-Y plane.

### BACKGROUND

Additive Manufacturing (AM), or 3D printing, is a process by which three-dimensional (3D) parts are manufactured based on computer-based models. The AM process is used to manufacture rapid prototypes as well as end-use products. Known AM techniques include binder jetting technique, directed energy deposition technique, material extrusion technique, material jetting technique, powder bed fusion technique, sheet lamination technique, vat photopolymerization technique, etc.

A conventional polymer material extrusion AM system includes a tool head that is configured to heat and extrude a material, and a platform on which the extruded material is deposited to manufacture a 3D part. The conventional polymer material extrusion AM system is limited by the maximum relative acceleration and speed of its moving components, thereby limiting the utility and application of the AM system.

Therefore, an AM system is required that operates at a higher speed/acceleration than the conventional polymer material extrusion AM systems.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an isometric view of a manufacturing system in accordance with the present disclosure.

FIG. 2 depicts a front view of the manufacturing system of FIG. 1 in accordance with the present disclosure.

FIG. 3 depicts a first top view of the manufacturing system of FIG. 1 in accordance with the present disclosure.

FIG. 4 depicts a second top view of the manufacturing system of FIG. 1 in accordance with the present disclosure.

FIG. 5 depicts a third top view of the manufacturing system of FIG. 1 in accordance with the present disclosure.

FIG. 6 depicts a flow diagram of a first manufacturing method in accordance with the present disclosure.

FIG. 7 depicts a flow diagram of a second manufacturing method in accordance with the present disclosure.

### DETAILED DESCRIPTION

### Overview

The present disclosure is directed to a multimodal motion system (“system”) for additive manufacturing (AM). In an exemplary aspect, the system may use polymer material extrusion AM technique for manufacturing 3-Dimensional (3D) parts. The system may include a tool head and a platform, both configured to move in an X-Y plane. The tool head may heat and extrude a material (e.g., a polymer), and the platform may receive the material extruded by the tool head to manufacture a 3D part. The system may further include a positioning assembly that may operate based on command signals received from a user device (e.g., a computer) communicatively coupled with the system. The positioning assembly may cause and control a tool head movement and/or a platform movement in the X-Y plane based on the command signals obtained from the computer. The system/positioning assembly may be configured to operate in three different operational modes.

In a first operational mode, the positioning assembly may cause the tool head movement and the platform movement simultaneously in opposite directions in the X-Y plane at the same speed and/or acceleration based on the command signals obtained from the computer. When the tool head and the platform move in opposite directions at the same speed, the effective 3D printing speed associated with the system is doubled, thereby significantly enhancing the system's operational efficiency. A user may cause the system to operate in the first operational mode when the user desires to manufacture the 3D part at a high speed/acceleration.

In some aspects, the positioning assembly may also be configured to cause the tool head movement and the platform movement simultaneously in opposite directions in the X-Y plane at different speeds and/or accelerations (e.g., a “differential mode”), based on system or build requirements/parameters (e.g., weight, dimensions, etc.).

In a second operational mode, the system may operate in a tool head-only mode. Stated another way, in the second operational mode, the positioning assembly may cause the tool head movement in the X-Y plane based on the command signals obtained from the computer and may disable the platform movement in the X-Y plane. The user may cause the system to operate in the second operational mode when the user desires to manufacture a 3D part that is more sensitive to vibrations and, therefore, benefits from a stationary platform.

In a third operational mode, the system may operate in a platform-only mode. Stated another way, in the third operational mode, the positioning assembly may cause the platform movement in the X-Y plane based on the command signals obtained from the computer and may disable the tool head movement in the X-Y plane. The user may cause the system to operate in the third operational mode when the tool head may be particularly heavy, complex, or otherwise spatially constrained.

In some aspects, the positioning assembly may include one or more tool head motors and one or more platform motors. The system may further include one or more tool head belts and one or more platform belts. The tool head may move in the X-Y plane via the tool head motors and the tool head belts. Similarly, the platform may move in the X-Y plane via the platform motors and the platform belts.

In some aspects, the tool head and the platform may additionally be configured to move vertically up or down along a Z-axis. In this case, the positioning assembly may further include Z-axis motors and the system may include Z-axis belts that may enable the tool head movement and/or the platform movement along the Z-axis.

The present disclosure discloses an AM system that facilitates manufacturing at a higher speed and acceleration as compared to a conventional polymer material extrusion AM system. Since the tool head and the platform may have a similar mass, and both are translated simultaneously and at the same speed in opposite directions, resulting system vibration caused by each is significantly reduced, thereby improving the quality of the manufactured object. Further, since the system is configured to operate in three different operational modes, the versatility and usefulness of the system is enhanced considerably.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

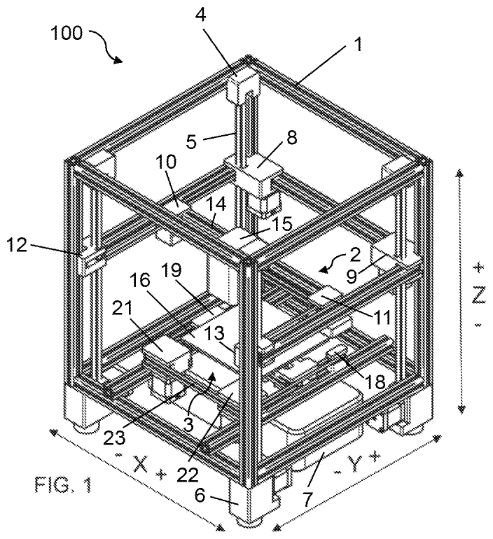

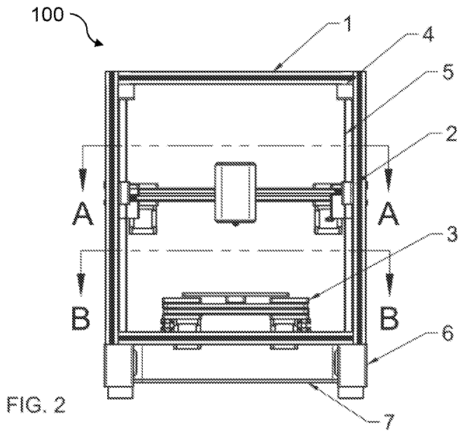

FIG. 1 depicts an isometric view of a manufacturing system 100 (or system 100) in accordance with the present disclosure. The system 100 may be an additive manufacturing (AM) system configured to manufacture three-dimensional (3D) parts based on computer-based models. In an exemplary aspect, the system 100 may use material extrusion AM technique to manufacture 3D parts. FIG. 1 will be described in conjunction with FIGS. 2-5.

In some aspects, the system 100 may be communicatively connected with a user device (not shown), which may be, for example, a computer, which may store a computer-based 3D model of a 3D part to be manufactured. The computer may be configured to slice the 3D model into layers (e.g., by using known 3D printing applications or software or firmware installed in the computer), perform calculations for each layer (toolpaths, extrusion commands, etc.), generate code by which the system 100 may be controlled and operated (such as g-code), and transmit code to the system 100 to control system operation and part manufacture. The system 100 may be configured to control a plurality of system components/units (described below) based on the command signals obtained from the computer to efficiently manufacture the 3D part.

The system 100 may include a plurality of components/units including, but not limited to, a frame 1, a tool head gantry 2, a platform gantry 3, a positioning assembly, an electronic unit enclosure 7, and/or the like. The electronic unit enclosure 7 is clearly depicted in FIG. 2, which illustrates a system front view. The electronic unit enclosure 7 may include one or more wired or wireless electronic components that may be communicatively coupled with the computer described above and the system components. In an exemplary aspect, the electronic components included in the electronic unit enclosure 7 may be configured to receive the command signals from the computer and cause operation of the various system components (e.g., the tool head gantry 2, the platform gantry 3, the positioning assembly, and/or the like) based on the received command signals.

In the present disclosure, an exemplary aspect is described below and depicted in FIGS. 1-5 in which the positioning assembly includes one or more motors. The present disclosure is not limited to such an aspect. In other aspects, the positioning assembly may include electromagnetic rails or any other means that may enable a tool head and/or a platform movement.

The frame 1 may be made of any metal, e.g., aluminum, steel, etc., and may be of any dimensions based on the system requirements. In the exemplary aspect depicted in FIG. 1, the frame 1 is a rectangular hollow structure with edges of similar dimensions. The frame 1 may be configured to securely support/hold the plurality of system components. The exemplary shape of the frame 1 depicted in FIG. 1 should not be construed as limiting. The frame 1 may have any shape as needed to accommodate alternate aspects/designs of the system 100, as long as the frame 1 is sufficiently rigid and square and maintains sufficient alignment between the different system components.

The tool head gantry 2 may be a metal structure and may include (or be attached with) one or more components including, but not limited to, first motor drive assemblies or first motors 8, 9 (or tool head motors), X-axis idlers 10, 11, Y-axis idlers 12, 13, one or more tool head belts 14, and a tool head assembly or a tool head 15.

The tool head 15 may be configured to heat and extrude a material (e.g., polymer) that may be used to manufacture the 3D part. The tool head 15 may be configured to move in an X-Y plane via the first motors 8, 9 and the tool head belts 14. Stated another way, the first motors 8, 9 may be configured to cause a tool head movement along an X-axis and/or a Y-axis (shown in FIG. 1) and the tool head belts 14 may enable the tool head movement in the X-Y plane.

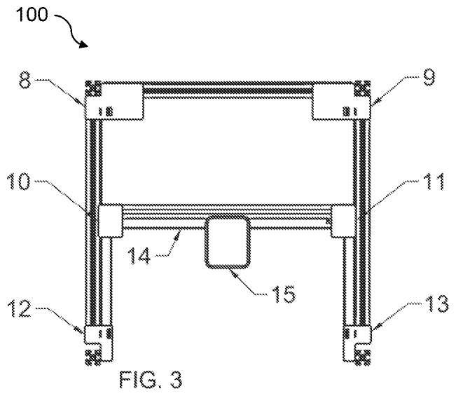

The first motors 8, 9 may be part of the positioning assembly described above and may be communicatively coupled with the electronic unit enclosure 7. The first motors 8, 9 may be configured to cause and control the tool head movement based on inputs/commands received from the electronic components/units included in the electronic unit enclosure 7. The X-axis idlers 10, 11 may be configured to guide the tool head belts 14 and maintain the position of the X-axis rails along the Y-axis rails. The X-axis idlers 10, 11 are clearly depicted in FIG. 3, which illustrates a system top-down view along a section A-A of FIG. 2. The system components below the tool head gantry 2 are not shown (or are hidden) in FIG. 3 for the sake of clarity.

The Y-axis idlers 12, 13 perform a similar function as the X-axis idlers 10, 11.

The tool head gantry 2 may be assembled and made to operate in any of the known configurations including, but not limited to, CoreXY, H-Bot, delta, SCARA, ball screw system, rack and pinion system, or any other configuration that enables efficient tool head and platform movement along the X and Y-axes or in the X-Y plane.

In additional aspects, the system 100 may include one or more Z-axis drive assemblies or Z-axis motors 6, one or more Z-axis belts 5 and one or more Z-axis idlers 4, as shown in FIG. 2. In an exemplary aspect, the system 100 may include four Z-axis motors 6, four Z-axis belts 5 and four Z-axis idlers 4. Each Z-axis motor 6 may be disposed at one corner (e.g., bottom corners) of the frame 1. Similarly, each Z-axis belt 5 may be disposed at each vertical edge (e.g., front left, front right, rear left and rear right edges) of the frame 1, and each Z-axis idler 4 may be disposed at each of the frame's top four corners.

The Z-axis motors 6 may be part of the positioning assembly described above. Further, the tool head gantry 2 (including the tool head 15) may be configured to move vertically up and down along the Z-axis via the Z-axis motors 6. Stated another way, the Z-axis motors 6 may be configured to move the tool head 15 along the Z-axis. In some aspects, the Z-axis motors 6 may be communicatively coupled with the electronic unit enclosure 7, and the electronic units included in the electronic unit enclosure 7 may cause and control the tool head gantry or tool head movement along the Z-axis via the Z-axis motors 6. The Z-axis belts 5 may enable the tool head gantry or tool head movement along the Z-axis.

A person ordinarily skilled in the art may appreciate from the description above that the tool head 15 may thus be configured to move in the X-axis, the Y-axis and the Z-axis via the positioning assembly (e.g., the first motors 8, 9 and the Z-axis motors 6) and the inputs/commands obtained from the electronic units included in the electronic unit enclosure 7.

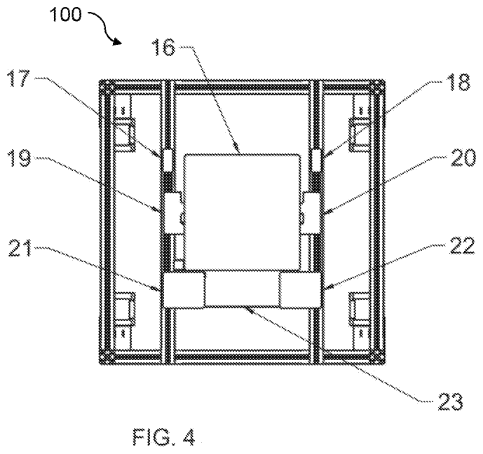

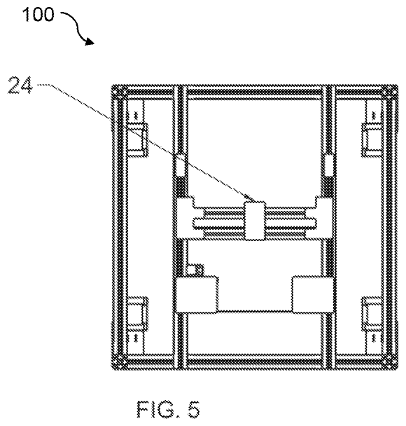

The platform gantry 3 may be a metal structure similar to the tool head gantry 2 to provide rigidity, and may include (or be attached with) one or more components including, but not limited to, a platform 16, Y-axis idlers 17, 18, X-axis idlers 19, 20, second motor drive assemblies or second motors 21, 22, one or more platform belts 23 and a platform mounting bracket 24, as shown clearly in FIGS. 4 and 5. FIG. 4 depicts a system top view along a section B-B of FIG. 2. The electronic unit enclosure 7 is not shown (or is hidden) in FIG. 4 for the sake of clarity. FIG. 5 also depicts a system top view. In FIG. 5, the electronic unit enclosure 7 and the platform 16 are not shown (or are hidden) for the sake of clarity.

The platform 16 may or may not be heated, and may be configured to receive the material extruded from the tool head 15. Similar to the tool head 15, the platform 16 may also be configured to move in the X-Y plane via the second motors 21, 22 and the platform belts 23. In some aspects, the second motors 21, 22 may be configured to cause a platform movement along the X-axis and/or the Y-axis, and the platform belts 23 may enable the platform movement in the X-Y plane.

Similar to the first motors 8, 9, the second motors 21, 22 may also be part of the positioning assembly described above, and may be communicatively coupled with the electronic unit enclosure 7. The second motors 21, 22 may be configured to cause and control the platform movement based on the inputs/commands received from the electronic units included in the electronic unit enclosure 7.

The purpose of the X-axis idlers 19, 20 and the Y-axis idlers 17, 18 is similar to the purpose of the X-axis idlers 10, 11 and the Y-axis idlers 12, 13.

The platform gantry 3 may be assembled and operated in the same manner as the tool head gantry 2. In some aspects, the platform gantry 3 may be assembled to operate in the CoreXY configuration; however, instead of attaching the platform 16 directly to the platform gantry 3, the platform 16 may be attached to the platform gantry 3 using or via the platform mounting bracket 24. In other aspects, the platform gantry 3 may be assembled to operate in the H-Bot, delta, SCARA, ball screw system, rack and pinion system, or any other configuration that enables efficient platform movement along the X and Y-axes or in the X-Y plane.

In some aspects, similar to the tool head gantry 2, the platform gantry 3 (including the platform 16) may also be configured to move vertically up and down along the Z-axis via the Z-axis motors 6. Stated another way, the Z-axis motors 6 may be configured to move the platform 16 along the Z-axis. In some aspects, the electronic units included in the electronic unit enclosure 7 may cause and control the platform gantry or platform movement along the Z-axis via the Z-axis motors 6. The Z-axis belts 5 may enable the platform gantry or platform movement along the Z-axis.

A person ordinarily skilled in the art may appreciate from the description above that the platform 16 may thus be configured to move in the X-axis, the Y-axis and the Z-axis via the positioning assembly (e.g., the second motors 21, 22 and the Z-axis motors 6) and the inputs/commands obtained from the electronic units included in the electronic unit enclosure 7.

In some aspects, the system 100, including the positioning assembly described above, may be configured to operate in three different operational modes, i.e., a first operational mode, a second operational mode, and a third operational mode. The system 100/positioning assembly may operate in any one of the three operational modes based on the command signals obtained from the computer via the electronic units included in the electronic unit enclosure 7.

When the system 100/positioning assembly operates in the first operational mode, both the tool head 15 and the platform 16 may move in the X-Y plane or along the X-axis or the Y-axis based on the inputs/command signals obtained from the computer via the electronic units included in the electronic unit enclosure 7. Stated another way, the first operational mode is a system “combination” operational mode, where both the tool head 15 and the platform 16 may simultaneously move in the X-Y plane.

In some aspects, when the system 100/positioning assembly operates in the first operational mode, the positioning assembly (i.e., the first motors 8, 9 and the second motors 21, 22) may cause the tool head movement and the platform movement simultaneously in opposite directions in the X-Y plane at a same speed and acceleration, based on the inputs/command signals obtained from the computer. Stated another way, the first motors 8, 9 and the second motors 21, 22 may cause the tool head 15 and the platform 16 to move simultaneously in opposite directions at the same speed/acceleration in the X-axis and/or the Y-axis when the system 100/positioning assembly operates in the first operational mode.

A person ordinarily skilled in the art may appreciate that when the tool head 15 and the platform 16 move simultaneously in the opposite directions at the same speed, the relative print speed of the system 100 is effectively doubled, enabling a high-speed system operation that is not possible using conventional AM systems. A conventional CoreXY AM system typically has a maximum print speed of 250-500 mm/second and acceleration of 5,000-10,000 mm/second-squared. The system 100, when operated in the first operational mode, may operate at a maximum relative print speed of 500-1,000 mm/second and acceleration of 10,000-20,000 mm/second-squared, thereby significantly enhancing the system's operational efficiency. Further, in some aspects, the tool head gantry 2 and the platform gantry 3 may have substantially similar masses. Due to the similar masses of the tool head gantry 2 and the platform gantry 3, system or machine vibrations are considerably reduced compared to a conventional CoreXY AM system when printing at high speeds. In some aspects, a user may operate the system 100/positioning assembly in the first operational mode when the user desires to manufacture a 3D part at a high speed and/or acceleration.

In some aspects, to simplify the assembly and operation of the system 100 in the first operational mode, the platform gantry 3 may be oriented 180 degrees about the Z-axis relative to the tool head gantry 2. This arrangement enables the second motors 21, 22 to be operated with the same command signals from the computer as the first motors 8, 9 while moving the platform 16 in the opposite direction of the tool head 15 at the same speed/acceleration. In alternate aspects, the platform gantry 3 may be oriented in the same direction as the tool head gantry 2. In this case, alternate wiring or firmware in the system 100 and/or software modifications in the computer may be used to reverse the tool head and platform movements as needed and described above.

In some aspects, the second operational mode may be a tool head-only system mode. Stated another way, when the system 100/positioning assembly operates in the second operational mode, only the tool head 15 moves in the X-Y plane and the platform 16 may be stationary in the X-Y plane. Specifically, the positioning assembly (i.e., the first motors 8, 9) may cause the tool head movement in the X-Y plane based on the inputs/command signals obtained from the computer and may disable the platform movement in the X-Y plane when the system 100/positioning assembly operates in the second operational mode. In some aspects, the system 100 operates similar to a conventional CoreXY AM system/machine when the system 100 operates in the second operational mode. The user may operate the system 100/positioning assembly in the second operational mode when the user desires to manufacture a 3D part that is more sensitive to vibrations and, therefore, benefits from a stationary platform.

In further aspects, the third operational mode may be a platform-only system mode. Stated another way, when the system 100/positioning assembly operates in the third operational mode, only the platform 16 moves in the X-Y plane and the tool head 15 may be stationary in the X-Y plane. Specifically, the positioning assembly (i.e., the second motors 21, 22) may cause the platform movement in the X-Y plane based on the inputs/command signals obtained from the computer and may disable the tool head movement in the X-Y plane when the system 100/positioning assembly operates in the third operational mode. In some aspects, when the system 100 operates in the platform-only mode, the system 100 may be used along with particularly heavy or complex toolheads that are prone to vibration or spatially constrained and, therefore, benefit from a static tool head. The user may operate the system 100/positioning assembly in the third operational mode when the system 100 may include a tool head that is particularly heavy, complex, or otherwise spatially constrained.

In some aspects, the system 100/positioning assembly may additionally be configured to operate in a “differential mode” in which the positioning assembly may cause the tool head movement and the platform movement simultaneously in opposite directions in the X-Y plane at different speeds and/or accelerations based on system or build requirements/parameters (e.g., weight, dimensions, etc.).

In further aspects, the tool head 15 and/or the platform 16 may be swappable. Stated another way, the tool head 15 may be swapped for other tool head configurations (lighter version for fast printing, multi-material tool head, high-resolution tool head, etc.). Similarly, the entire platform gantry 3 may be swapped out for a larger stationary platform that could use the entire X-Y area that the moving platform would otherwise occupy.

In some aspects, when the system 100 operates in the second operational mode (i.e., the tool head-only system mode), the software in the computer and/or firmware in the system 100 may be configured to operate a CoreXY AM system/machine. To operate the system 100 in the third operational mode (i.e., the platform-only mode), the software in the computer and/or the firmware in the system 100 may be reconfigured by changing the board pin references that originally referred to the first motors 8, 9 and tool head end stop sensors (not shown) to the updated values for the second motors 21, 22 and platform end stop sensors (not shown). A person ordinarily skilled in the art may appreciate that depending on the orientation of the platform gantry 3, the direction pin may need to be reversed.

Furthermore, to operate the system 100 in the first operational mode (i.e., the combination operational mode), new sections may be added to the configuration file of the firmware for the second motors 21, 22 and the platform end stop sensors rather than replacing the values for the first motors 8, 9 and the tool head end stop sensors. In an exemplary aspect, the new sections may be assigned the same names as the original, along with an appended identifier. This allows the same signals from the computer to be used to control the first motors 8, 9 and the second motors 21, 22 in tandem. In alternative aspects, the first and second motors may simply be wired to operate in parallel without any firmware modifications. In yet another aspect, the computer may use a combination of the three firmware configurations described above (i.e., associated with the first, second and third operational modes) to form a single configuration with different sections that can be referenced depending on the desired system operational mode.

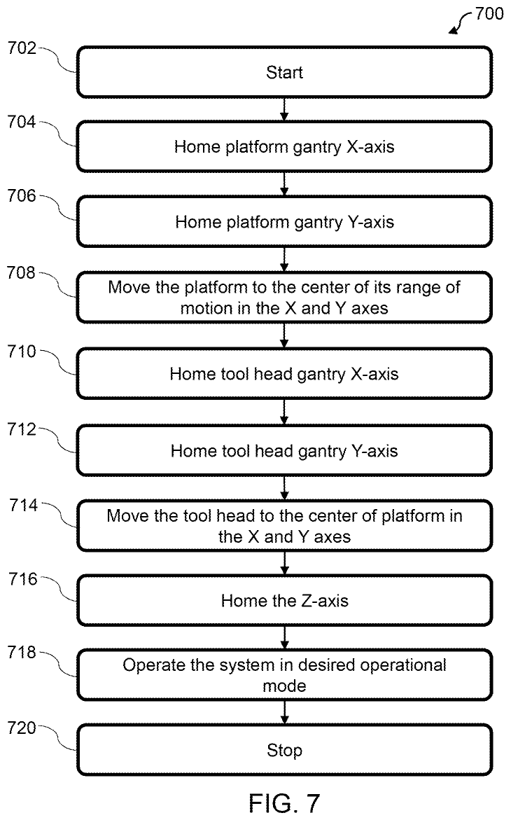

To operate the system 100 efficiently, each axis (i.e., the X-axis, the Y-axis and the Z-axis) must first be “homed”, or moved in the negative axis direction until the corresponding end stop sensor is triggered. A person ordinarily skilled in the art may appreciate that each axis may be homed by using commands that are available in a typical CoreXY firmware/software. However, for the system 100, the homing operation also needs to be completed for the platform gantry 3. An example order of homing operations is described later below in conjunction with FIG. 7. Once all the axes are homed, the system 100 may be operated in the desired operational mode (i.e., the first, second or third operational mode) to manufacture a 3D part.

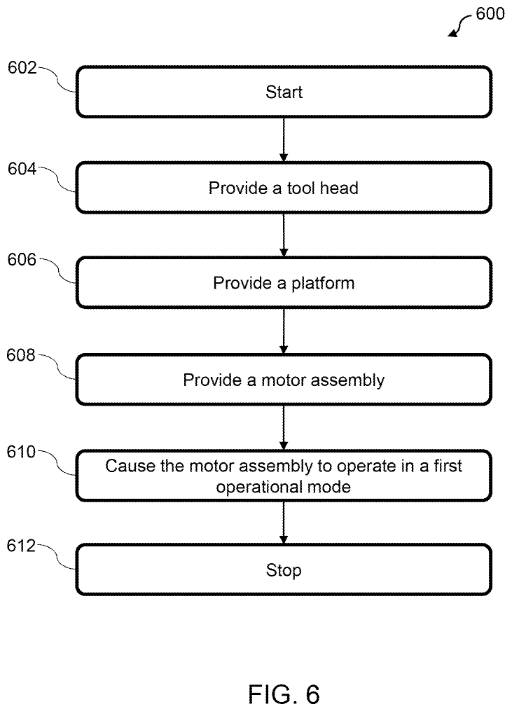

FIG. 6 depicts a flow diagram of a first manufacturing method 600 in accordance with the present disclosure. FIG. 6 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 600 starts at step 602. At step 604, the method 600 may include providing the tool head 15. At step 606, the method 600 may include providing the platform 16. At step 608, the method 600 may include providing the positioning assembly, including the first motors 8, 9, the second motors 21, 22 and the Z-axis motors 6. At step 610, the method 600 may include causing the positioning assembly to operate in the first operational mode.

As described above, the positioning assembly may be further configured to operate in the second operational mode or the third operational mode based on user or system requirements. In some aspects, the method 600 may include additional steps (not shown) of causing the positioning assembly to operate in the second operational mode or the third operational mode based on the user or system requirements.

At step 612, the method 600 may stop.

FIG. 7 depicts a flow diagram of a second manufacturing method 700 in accordance with the present disclosure. The method 700 may be implemented to “home” and operate the system 100. FIG. 7 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 700 starts at step 702. At step 704, the method 700 may include homing the platform gantry X-axis. At step 706, the method 700 may include homing the platform gantry Y-axis. Stated another way, at steps 704 and 706, the platform gantry 3 may be homed in the X and Y-axes.

At step 708, the method 700 may include moving the platform 16 to the center of its range of motion in the X and Y-axes. At step 710, the method 700 may include homing the tool head gantry X-axis. At step 712, the method 700 may include homing the tool head gantry Y-axis. Stated another way, at steps 710 and 712, the tool head gantry 2 may be homed in the X and Y-axes.

At step 714, the method 700 may include moving the tool head 15 to the center of the platform 16 in the X and Y-axes. At step 716, the method 700 may include homing the system Z-axis. At step 718, the method 700 may include operating the system 100 in the desired operational mode (i.e., the first, second or third operational mode).

At step 720, the method 700 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A manufacturing system comprising:
a tool head for extruding a material, wherein the tool head is configured to move in an X-Y plane;
a platform for receiving the material from the tool head, wherein the platform is configured to move in the X-Y plane; and
a positioning assembly configured to cause a tool head movement and a platform movement simultaneously in opposite directions in the X-Y plane at a same speed and acceleration, when the positioning assembly operates in a first operational mode.

2. The manufacturing system of claim 1, wherein the manufacturing system is an additive manufacturing system.

3. The manufacturing system of claim 1, wherein the tool head is further configured to move along a Z-axis, and wherein the positioning assembly is further configured to cause the tool head movement along the Z-axis.

4. The manufacturing system of claim 1, wherein the platform is further configured to move along a Z-axis, and wherein the positioning assembly is further configured to cause the platform movement along the Z-axis.

5. The manufacturing system of claim 1, wherein the positioning assembly comprises a first motor and a second motor.

6. The manufacturing system of claim 5, wherein the first motor is configured to move the tool head in the X-Y plane, and wherein the second motor is configured to move the platform in the X-Y plane.

7. The manufacturing system of claim 5 further comprising a tool head gantry and a platform gantry, wherein the first motor is disposed at the tool head gantry, and wherein the second motor is disposed at the platform gantry.

8. The manufacturing system of claim 7, wherein the tool head gantry comprises a tool head belt configured to enable the tool head movement in the X-Y plane, and wherein the platform gantry comprises a platform belt configured to enable the platform movement in the X-Y plane.

9. The manufacturing system of claim 1, wherein the positioning assembly is further configured to operate in a second operational mode and a third operational mode.

10. The manufacturing system of claim 9, wherein the positioning assembly is configured to cause the tool head movement in the X-Y plane and disable the platform movement in the X-Y plane when the positioning assembly operates in the second operational mode.

11. The manufacturing system of claim 9, wherein the positioning assembly is configured to cause the platform movement in the X-Y plane and disable the tool head movement in the X-Y plane when the positioning assembly operates in the third operational mode.

12. A manufacturing system comprising:
a tool head for extruding a material, wherein the tool head is configured to move in an X-Y plane;
a platform for receiving the material from the tool head, wherein the platform is configured to move in the X-Y plane; and
a positioning assembly configured to operate in a first operational mode, a second operational mode, and a third operational mode, wherein:
the positioning assembly causes a tool head movement and a platform movement simultaneously in opposite directions in the X-Y plane at a same speed and acceleration when the positioning assembly operates in the first operational mode,
the positioning assembly causes the tool head movement in the X-Y plane and disables the platform movement in the X-Y plane when the positioning assembly operates in the second operational mode, and
the positioning assembly causes the platform movement in the X-Y plane and disables the tool head movement in the X-Y plane when the positioning assembly operates in the third operational mode.

13. The manufacturing system of claim 12, wherein the tool head is further configured to move along a Z-axis, and wherein the positioning assembly is further configured to cause the tool head movement along the Z-axis.

14. The manufacturing system of claim 12, wherein the platform is further configured to move along a Z-axis, and wherein the positioning assembly is further configured to cause the platform movement along the Z-axis.

15. The manufacturing system of claim 12, wherein the positioning assembly comprises a first motor and a second motor.

16. The manufacturing system of claim 15, wherein the first motor is configured to move the tool head in the X-Y plane, and wherein the second motor is configured to move the platform in the X-Y plane.

17. The manufacturing system of claim 15 further comprising a tool head gantry and a platform gantry, wherein the first motor is disposed at the tool head gantry, and wherein the second motor is disposed at the platform gantry.

18. A manufacturing method comprising:
providing a tool head for extruding a material, wherein the tool head is configured to move in an X-Y plane;
providing a platform for receiving the material from the tool head, wherein the platform is configured to move in the X-Y plane;
providing a positioning assembly configured to operate in a first operational mode, a second operational mode and a third operational mode; and
causing the positioning assembly to operate in the first operational mode, wherein the positioning assembly causes a tool head movement and a platform movement simultaneously in opposite directions in the X-Y plane at a same speed and acceleration when the positioning assembly operates in the first operational mode.

19. The manufacturing method of claim 18 further comprising causing the positioning assembly to operate in the second operational mode, wherein the positioning assembly causes the tool head movement in the X-Y plane and disables the platform movement in the X-Y plane when the positioning assembly operates in the second operational mode.

20. The manufacturing method of claim 18 further comprising causing the positioning assembly to operate in the third operation mode, wherein the positioning assembly causes the platform movement in the X-Y plane and disables the tool head movement in the X-Y plane when the positioning assembly operates in the third operational mode.
